(19) United States
(12) Patent Application Publication
(10) Pub. No.: US 2026/0060211 A1
(43) Pub. Date: Mar. 5, 2026

(54) PET WATER DISPENSER

(71) Applicant: Dongguan ZhiYiHong Hardware & Plastic Co., Ltd., Dongguan (CN)

(72) Inventor: Zhiqi Xue, Dongguan (CN)

(73) Assignee: Dongguan ZhiYiHong Hardware & Plastic Co., Ltd., Dongguan (CN)

(21) Appl. No.: 19/270,960

(22) Filed: Jul. 16, 2025

(30) Foreign Application Priority Data
Aug. 30, 2024 (CN) 202422125849.3

(51) Int. Cl. A01K 7/02; A01G 27/00

(52) U.S. Cl. CPC A01K 7/025; A01G 27/003

(57) ABSTRACT

A pet water dispenser includes a feed-water tank, a drinking device and an evaporator; a water container is arranged in the feed-water tank; the drinking device includes a drinking bowl, and a control valve which is connected to the drinking bowl and the feed-water tank and controls communication and separation between the drinking bowl and the feed-water tank; the evaporator includes a water tray and a water intake assembly; the water tray is in butt joint with the control valve which controls the communication and separation between the drinking bowl and the water tray; the water intake assembly is arranged in the water tray, with surface area larger than the bottom area of the water tray. Wastewater is automatically evaporated, thus avoiding inconvenience in wastewater treatment by a user, and also preventing water in the drinking bowl from entering the feed-water tank to cause water body pollution.

### FIELD OF THE INVENTION

The present application relates to the technical field of pet supplies, and specifically relates to a pet water dispenser.

### BACKGROUND OF THE INVENTION

With the increasing of households raising animals, more and more pet owners pay attention to dietary health of pets (such as cats and dogs).

To make it easier for pets to drink water, there is currently a type of pet water dispenser available on the market. These water dispensers can generally automatically transport clean water into drinking bowls for the pets, which avoids inconvenience of refilling water by users every time.

However, drinking water in the existing pet water dispensers can only circulate between the drinking bowls and feed-water tanks, organic matters in pet mouths will flow back into the feed-water tanks by means of the drinking bowls, and finally accumulate in the feed-water tanks, resulting in severe bacterial contamination to the water in the feed-water tanks. This not only requires the users to regularly clean the feed-water tanks and the drinking bowls but also poses a threat to pet health.

Therefore, it is necessary to propose a new technical solution to solve the above technical problems.

### SUMMARY OF THE INVENTION

An objective of the present application is to provide a pet water dispenser to solve the safety problem of pet drinking water.

In order to solve the above problem, the technical solution of the present application is as follows.

The present application provides a pet water dispenser, comprising:
a feed-water tank in which a water container is arranged;
a drinking device comprising a drinking bowl and a control valve, the control valve being connected to the drinking bowl and the feed-water tank, and the control valve controlling communication and separation between the drinking bowl and the feed-water tank; and
an evaporator comprising a water tray and a water intake assembly, the water tray being in butt joint with the control valve, the control valve controlling the communication and separation between the drinking bowl and the water tray, and the water intake assembly being arranged in the water tray, with the surface area greater than the bottom area of the water tray.

Further, the evaporator is positioned below the feed-water tank and further comprises a shell; the feed-water tank and the drinking bowl are both mounted on the shell; the shell and the water tray are assembled to form an evaporation chamber, and the water intake assembly is positioned in the evaporation chamber; and air holes are formed in the side wall of the shell, and the evaporation chamber is in communication with outside through the air holes.

Further, the water intake assembly is of a plate-shaped structure folded in a wavy mode.

Further, the top surface of the water intake assembly is higher than the top surface of the water tray.

Further, a part of the water tray is positioned below a joint of the drinking bowl and the control valve.

Further, the pet water dispenser further comprises a planting pot, wherein the planting pot is mounted on one side of the evaporator, a water inlet of the planting pot is in communication with the drinking bowl, and a water outlet of the planting pot is in butt joint with a water inlet of the water tray.

Further, the pet water dispenser further comprises a flow guide member which is positioned between the drinking bowl and the planting pot, wherein the head end of the flow guide member is in butt joint with the control valve, and the tail end of the flow guide member is positioned at the water inlet of the planting pot.

Further, the tail end of the flow guide member is positioned above the water tray, and the planting pot is detachably connected to the water tray.

Further, the planting pot is provided with an inlet water buffer tank, a planting tank and a water drainage channel; the tail end of the flow guide member is positioned above the inlet water buffer tank, the inlet water buffer tank is in communication with the planting tank, the planting tank is in communication with the drainage channel, and the tail end of the drainage channel is positioned above the water tray.

Further, at least two water inlet notches are formed in the side wall, close to the inlet water buffer tank, of the planting tank and are distributed in the length extending direction of the inlet water buffer tank.

Further, the bottom surface of the inlet water buffer tank is higher than the bottom surface of the planting tank.

Further, salt is placed in the water tray.

Further, an anti-corrosion compound is placed in the water tray.

Further, the evaporator also comprises a fan which is mounted in the evaporation chamber, and an air outlet of the fan is arranged towards the water intake assembly.

Further, the evaporator also comprises an electric heating member which is mounted on the water tray.

Further, a positioning frame is also arranged in the evaporator and is positioned in the water tray, and the water intake assembly is detachably arranged in the positioning frame.

Further, the control valve comprises a valve body, a valve core and a driving mechanism; the valve body is provided with a first channel connector and a second channel connector, the first channel connector is in communication with the water outlet end of the feed-water tan, and the second channel connector is in communication with the water inlet of the water tray; the valve core is mounted on the valve body and is provided with a channel opening and closing port, and the channel opening and closing port is in communication with a water flow channel of the drinking bowl; the driving mechanism is in transmission connection with the valve core; and the channel opening and closing port is driven by the driving mechanism to move.

Further, a position indicating portion is arranged on the valve core; and the control valve further comprises a position sensor which is arranged corresponding to the position indicating portion, and the position sensor is electrically connected to the driving mechanism.

Further, the pet water dispenser further comprises a connecting water pipe, wherein one end of the connecting water pipe is in communication with the feed-water tank, and the other end of the connecting water pipe is in communication with the first channel connector; and the connecting water pipe is positioned above the water tray.

Further, the drinking bowl is lower than the bottom of the feed-water tank, and the water tray is lower than the bottom of the drinking bowl.

In the present application, a drinking bowl is arranged to be in communication with a feed-water tank and an evaporator by means of a control valve, so that when the pet water dispenser is in a water supply state, water can be added to the drinking bowl by the feed-water tank; and when the pet water dispenser is in a water drainage state, the drinking bowl can transport water inside into the evaporator, therefore, the water in the drinking bowl is prevented from entering the feed-water tank again to cause water body pollution, it is ensured that a pet can always drink clean water, and the drinking water safety of the pet is ensured. According to the present application, a water tray and a water intake assembly are arranged in the evaporator, so that the water which is not drunk by the pet in the drinking bowl can be drained to the water tray to be collected; and because the water intake assembly with a larger surface area is arranged in the water tray, wastewater can be taken in by the water intake assembly and accelerated to be evaporated; and therefore, the wastewater can be automatically evaporated, the user does not need to clean the wastewater additionally, which reduces the trouble of the user treating the wastewater and is beneficial for the user to keep a good living environment.

### BRIEF DESCRIPTION OF THE DRAWINGS

FIG. 1 is a schematic structural diagram of an Embodiment 1 of a pet water dispenser provided by the present application;

FIG. 2 is a rear view of a pet water dispenser shown in FIG. 1;

FIG. 3 is a cross-sectional view of a part A-A′ in FIG. 2;

FIG. 4 is an exploded view of a pet water dispenser shown in FIG. 1;

FIG. 5 is a schematic diagram of an internal structure of a pet water dispenser shown in FIG. 1;

FIG. 6 is a schematic diagram of a connection relationship between a drinking device, a flow guide member and a connecting water pipe in a pet water dispenser shown in FIG. 1;

FIG. 7 is an exploded view of a valve body and a valve core in a pet water dispenser shown in FIG. 1;

FIG. 8 is a schematic structural diagram of a planting pot in a pet water dispenser shown in FIG. 1;

FIG. 9 is a schematic structural diagram of an Embodiment 1 of a water intake assembly in a pet water dispenser shown in FIG. 1; and

FIG. 10 is a schematic structural diagram of an Embodiment 2 of a water intake assembly.

### REFERENCE NUMERALS

100, feed-water tank; 101, water container;
200, drinking device; 210, drinking bowl; 220, control valve; 221, valve body; 2211, first channel connector; 2212, second channel connector; 222, valve core; 2221, channel opening and closing port; 2222, position indicating portion; 223, driving mechanism; 224, position sensor;
300, evaporator; 310, water tray; 320, water intake assembly; 321, groove; 330, shell; 331, air hole; 332, water tank water outlet; 340, positioning frame;
400, planting pot; 410, inlet water buffer tank; 320, planting tank; 421, water inlet notch; 430, drainage channel;
500, flow guide member; and
600, connecting water pipe.

### DETAILED DESCRIPTION OF SOME EMBODIMENTS

The meanings of the terms used in this specification and the claims correspond to the meanings understood by those of ordinary skill in the art related to the present application. The terms used in this specification and the claims are only for the purpose of facilitating the narration and understanding of the present application, and are not intended to limit the present application to a narrow interpretation of the specific terms used in the specification and the claims.

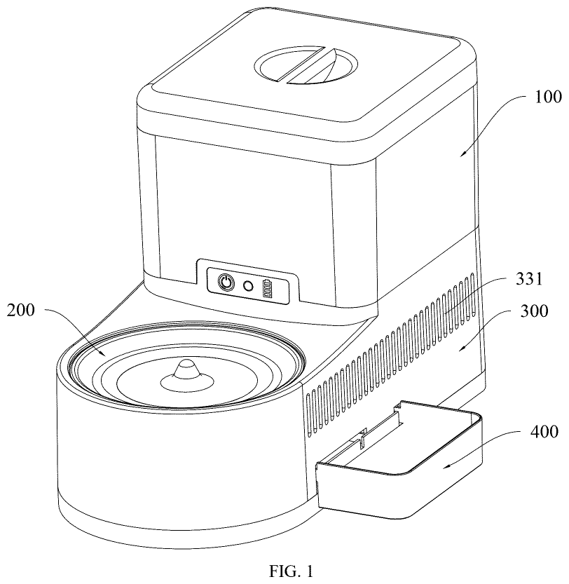

With reference to FIG. 1 to FIG. 9, the present application provides a pet water dispenser. The pet water dispenser includes a feed-water tank 100, a drinking device 200 and an evaporator 300. A water container 101 is arranged in the feed-water tank 100. The drinking device 200 includes a drinking bowl 210 and a control valve 220, in which, the control valve 220 is connected to the drinking bowl 210 and the feed-water tank 100 and controls communication and separation between the drinking bowl 210 and the feed-water tank 100. The evaporator 300 includes a water tray 310 and water intake assemblies 320, in which, the water tray 310 is in butt joint with the control valve 220, the control valve 220 controls the communication and separation between the drinking bowl 210 and the water tray 310; and the water intake assemblies 320 are arranged in the water tray 310, with the surface area larger than the bottom area of the water tray 310.

In the pet water dispenser according to the present application, the drinking bowl 210 is arranged to be in communication with the feed-water tank 100 and the evaporator 300 by the control valve 220, respectively, so that when the pet water dispenser is in a water supply state, water can be added to the drinking bowl 210 by the feed-water tank 100; and when the pet water dispenser is in a water drainage state, the drinking bowl 210 can transport the water inside into the evaporator 300, which prevents the water in the drinking bowl from entering the feed-water tank 100 again to cause water body pollution. In the present application, the water tray 310 and the water intake assemblies 320 are arranged in the evaporator 300, so that the water which is not drunk by a pet in the drinking bowl 210 can be drained into the water tray 310 to be collected; the water intake assemblies 320 with a larger surface area are arranged in the water tray 310, thus the wastewater can be taken in by the water intake assemblies 320 and accelerated to be evaporated, the automatic evaporation treatment to the wastewater is realized, and the user does not need to clean the wastewater additionally; on one hand, the wastewater is not cycled, which ensures the water drinking safety of the pet; and on the other hand, the trouble of the user treating the wastewater is reduced, and it is beneficial for the user to keep a good living environment.

In order to make those skilled in the art better understand the solution of the present application, the technical solutions in the embodiments of the present application will be described clearly and completely below in conjunction with the accompanying drawings.

An Embodiment 1 of a pet water dispenser in the present application.

As shown in FIG. 1 to FIG. 9, in this embodiment, the pet water dispenser includes a feed-water tank 100, a drinking device 200 and an evaporator 300. A water container 101 is arranged in the feed-water tank 100. The drinking device 200 includes a drinking bowl 210 and a control valve 220, in which, the control valve 220 is connected to the drinking bowl 210 and the feed-water tank 100, and the control valve 220 controls communication and separation between the drinking bowl 210 and the feed-water tank 100. The evaporator 300 includes a water tray 310 and water intake assemblies 320, in which, the water tray 310 is in butt joint with the control valve 220, the control valve 220 controls the communication and separation between the drinking bowl 210 and the water tray 310; and the water intake assemblies 320 are arranged in the water tray 310, with the surface area larger than the bottom area of the water tray 310.

Specifically, the water container in the feed-water tank 100 is used for storing clean water for a pet. The control valve 220 can control the communication between the drinking bowl 210 and the feed-water tank 100 or communication between the drinking bowl 210 and the water tray 310. When the pet water dispenser is in a water supply state, the control valve 220 opens a channel between the drinking bowl 210 and the feed-water tank 100 and cuts off a channel between the drinking bowl 210 and the water tray 310, so that clean water in the feed-water tank 100 can enter the drinking bowl 210; when the pet water dispenser is in a waiting state for drinking water, the control valve 220 cuts off the channel between the drinking bowl 210 and the feed-water tank 100 and the channel between the drinking bowl 210 and the water tray 310, so that water in the drinking bowl 210 is in a static state and waits for the pet to drink; and when the pet water dispenser is in a water drainage state, the control valve 220 opens the channel between the drinking bowl 210 and the water tray 310 and cuts off the channel between the drinking bowl 210 and the feed-water tank 100, and thus water remaining in the drinking bowl 210 can be drained into the water tray 310. After the pet drinks water, organic matters will be brought into the drinking bowl 210, and because the pet often cannot drink up all water in the drinking bowl 210, the water in the drinking bowl 210 is prone to generating bacteria, which is not beneficial to the health of the pet, and it is needed to replace the water in the drinking bowl 210 regularly. In this embodiment, water drainage and water supply of water in the drinking bowl 210 are controlled by means of the control valve 220, and one-time water replacement is achieved. In this embodiment, the water remaining (hereinafter referred to as wastewater) in the drinking bowl 210 does not enter the feed-water tank 100 anymore but enters the evaporator 300, so that the wastewater is prevented from polluting water body in the feed-water tank 100, and it is ensured that the pet can drink clean water all the time.

In prior art, some pet water dispensers are equipped with filter elements, but micropores in the filter elements still easily breed bacteria; there are also some pet water dispensers that collect the water in the drinking bowl into a wastewater tank, but the wastewater tank is prone to smelling bad after collecting water, required to be emptied by the user timely, which is very inconvenient to use.

According to the present application, the water tray 310 and the water intake assemblies 320 are arranged in the evaporator 300, so that water which is not drunk by the pet in the drinking bowl 210 can be drained into the water tray 310 to be collected; the water intake assemblies 320 with a larger surface area are arranged in the water tray 310, thus the wastewater can be taken in by the water intake assemblies 320 and accelerated to be evaporated, the automatic evaporation treatment of the wastewater is realized, and the user does not need to clean the wastewater additionally; on one hand, the wastewater is not cycled, which ensures the water drinking safety of the pet; and on the other hand, the trouble of the user treating the wastewater is reduced, and it is beneficial for the user to keep a good living environment.

In this embodiment, the water intake assemblies 320 are positioned in the water tray 310, with the surface area larger than the bottom area of the water tray 310, so after the wastewater is take in by the water intake assemblies 320, the contact area of the wastewater and air can be increased; and after the wastewater contact with the air in a large area, a large evaporation amount will be produced, thus the wastewater can be transformed into water vapor to be consumed, and the user does not need to clean the wastewater in the water tray 310 additionally.

As shown in FIG. 1 to FIG. 4, in this embodiment, the evaporator 300 is positioned below the feed-water tank 100 and further includes a shell 330; the feed-water tank 100 and the drinking bowl 210 are both mounted on the shell 330; the shell 330 and the water tray 310 are assembled to form an evaporation chamber, and the water intake assemblies 320 are positioned in the evaporation chamber; and air holes 331 are formed in the side wall of the shell 330, and the evaporation chamber is in communication with the outside through the air holes 331.

Specifically, in this embodiment, the evaporator 300 is arranged below the feed-water tank 100, and the feed-water tank 100 and the drinking bowl 210 are both mounted on the shell 330 of the evaporator 300, so that all parts of the pet water dispenser are more compact in structure and higher in integrity, space is utilized properly, and the area occupied by the pet water dispenser is reduced. The air holes 331 are formed in the side wall of the shell 330, the evaporation chamber is in communication with the outside through the air holes 331, thus air can enter the evaporation chamber through the air holes 331, and water vapor in the evaporation chamber can be discharged into outside air through the air holes 331.

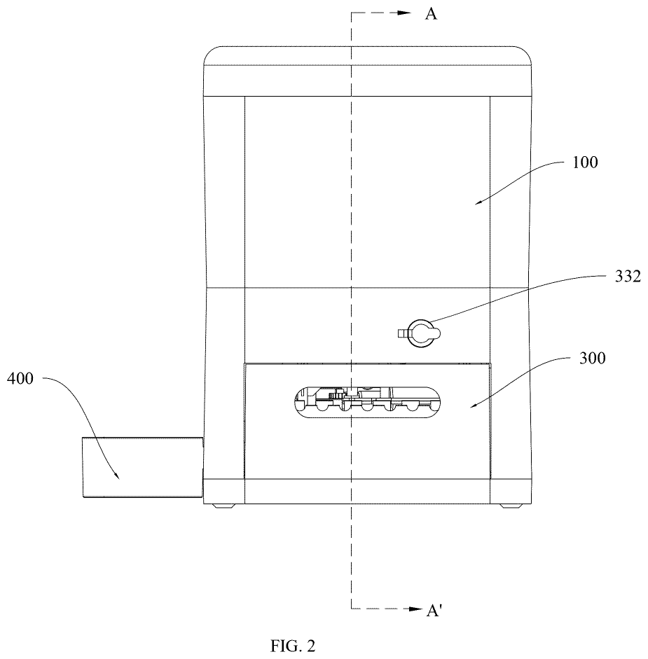

As shown in FIG. 2, in this embodiment, the shell 330 is further provided with a feed-water tank water outlet 332 and a piston arranged on the water tank water outlet 332, and the water tank water outlet 332 is in communication with the feed-water tank 100 and is positioned below the feed-water tank 100. When water in the feed-water tank 100 is not used up yet and the user wants to replace with clean water in the feed-water tank 100, the piston can be pulled out to open the water tank water outlet 332 for draining water from the feed-water tank 100; and after water in the feed-water tank 100 is completely drained, the water tank water outlet 332 is closed by means of the piston, and new clean water is poured from the upper portion of the feed-water tank 100.

In this embodiment, the water intake assemblies 320 is of a plate-shaped structure folded in a wavy mode. Specifically, the water intake assemblies 320 is folded in the wavy mode, which greatly increases the contact area of wastewater in the water absorption assemblies 320 and air, leading to an increase in the evaporation amount of wastewater; in addition, the plate-shaped structure folded in the wavy mode is adopted, it is ensured that the water intake assemblies 320 can evenly take in wastewater in the water tray 310, moreover, the wastewater in the water tray 310 can be exposed, air can flow in gaps between the water absorption assemblies 320, and thus the wastewater is accelerated to be evaporated into water vapor.

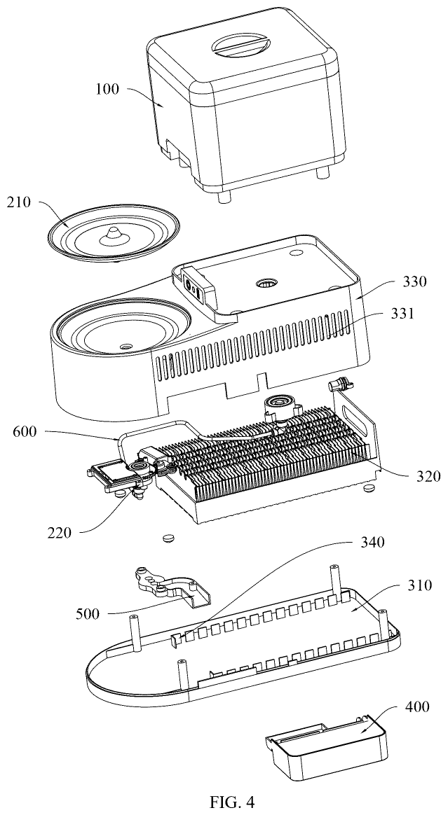

As shown in FIG. 4 and FIG. 9, in this embodiment, grooves 321 are formed in wave ridges on the sides, far away from the water tray 310, of the water intake assemblies 320. The grooves 321 are arranged to further increase the contact area between wastewater in the water intake assemblies 320 and air, and thus the evaporation of the wastewater is further accelerated.

In this embodiment, the water intake assemblies 320 is made of one of cotton, a mineral porous material (diatomite) or porous ceramic.

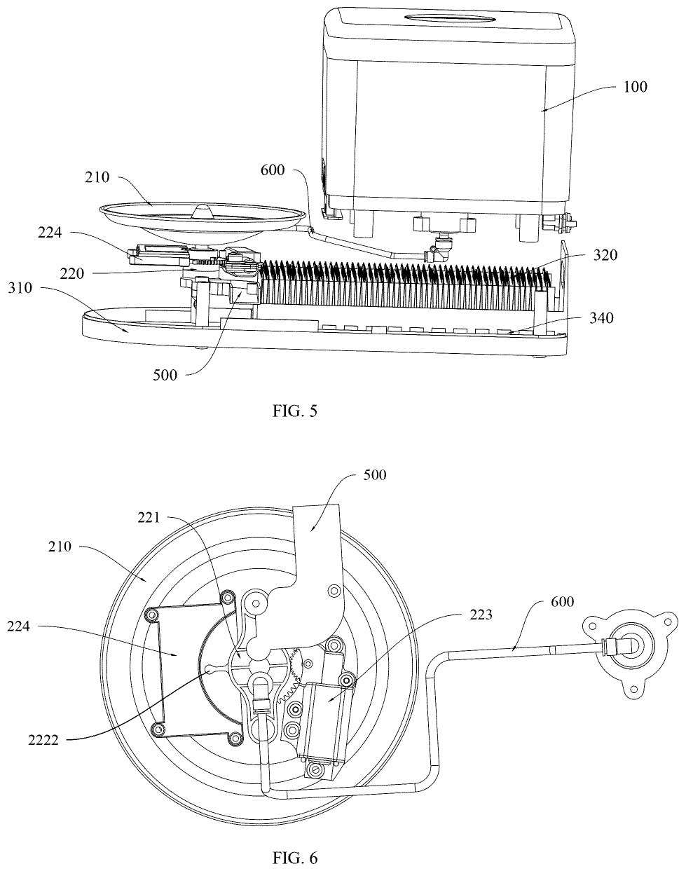

As shown in FIG. 5, in this embodiment, at least a part of the water intake assemblies 320 is positioned below the feed-water tank 100, so that the arrangement of all the parts is more compact, and the space is saved.

In this embodiment, the top surfaces of the water intake assemblies 320 are higher than the top surface of the water tray 310, so the space occupied by the water intake assemblies 320 is larger, the evaporator 300 can accommodate more water, and excessive wastewater is prevented from overflowing out of the water tray 310.

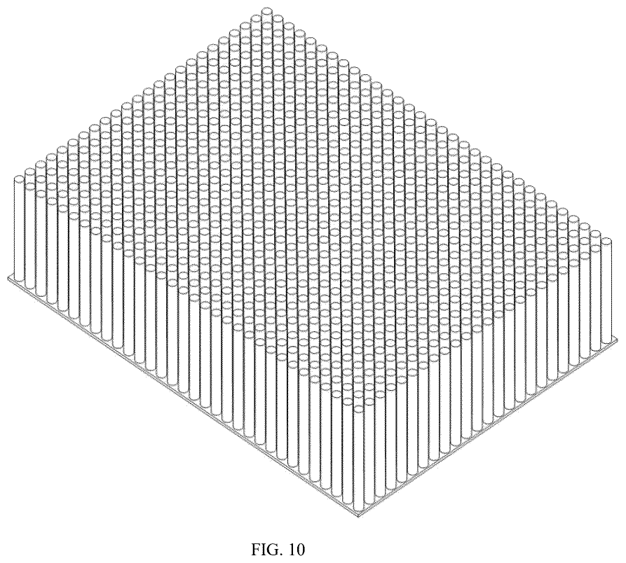

In this embodiment, the water intake assemblies 320 form a matrix structure in repeated arrangement. In some embodiments, the water intake assemblies 320 can also be arranged in a form of a cylindrical structure (as shown in FIG. 10).

As shown in FIG. 5, in this embodiment, a part of the water tray 310 is positioned below the joint of the drinking bowl 210 and the control valve 220. Specifically, the water tray 310 is positioned below the joint of the drinking bowl 210 and the control valve 220, so that the bottom area of the water tray 310 can be larger while the whole pet water dispenser is smaller; and moreover, the water tray 310 can also catch leaked water at the joint of the drinking bowl 210 and the control valve 220.

As shown in FIG. 1 to FIG. 4, in this embodiment, the pet water dispenser further includes a planting pot 400 which is mounted on one side of the evaporator 300, a water inlet of the planting pot 400 is in communication with the drinking bowl 210, and a water outlet of the planting pot 400 is in butt joint with a water inlet of the water tray 310. In this embodiment, the planting pot 400 is used for planting plants such as catnip. The planting pot 400 can further improve the utilization rate of wastewater, the wastewater drained from the drinking bowl 210 flows through the planting pot 400 to irrigate the plants in the planting pot 400, and then excessive water after irrigation enters the water tray 310 of the evaporator 300 from the planting pot 400 and is consumed through evaporation by the evaporator.

As shown in FIG. 4, FIG. 5, and FIG. 6, in this embodiment, the pet water dispenser further includes a flow guide member 500 which is positioned between the drinking bowl 210 and the planting pot 400, the head end of the flow guide member 500 is in butt joint with the control valve 220, and the tail end of the flow guide member 500 is positioned at the water inlet of the planting pot 400. The flow guide member 500 is used for guiding the wastewater drained from the drinking bowl 210, and the wastewater can enter the planting pot 400 under the guidance of the flow guide member 500.

In this embodiment, the tail end of the flow guide member 500 is positioned above the water tray 310, and the planting pot 400 is detachably connected to the water tray 310. When the user does not need to plant the plants or the plants in the planting pot 400 do not need to be irrigated, the planting pot 400 can be detached from the water tray 310, and the flow guide member 500 will guide the wastewater to be drained into the water tray 310.

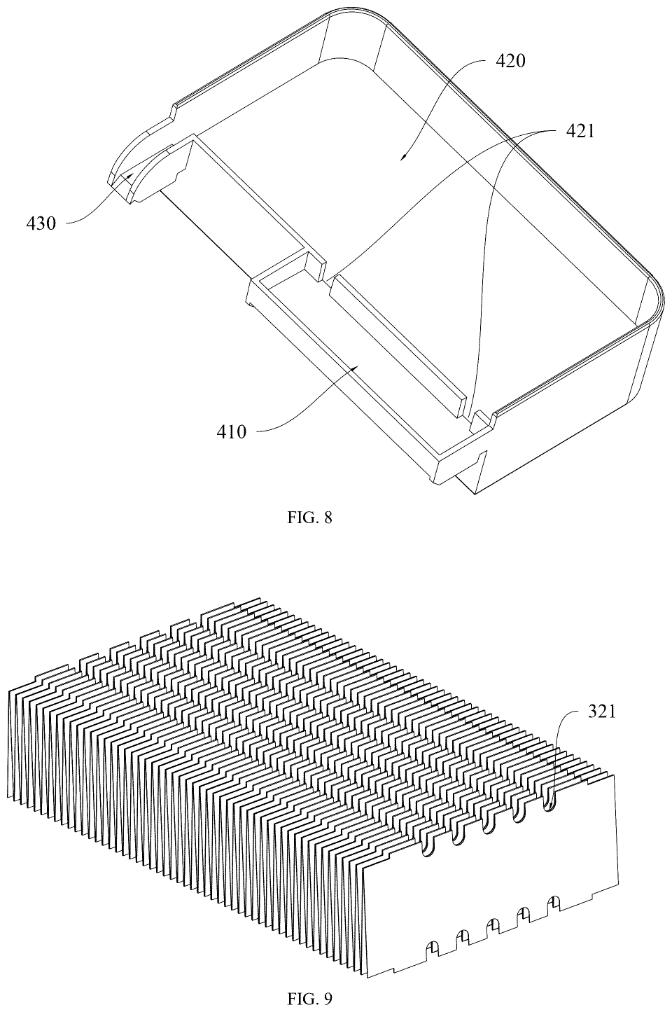

As shown in FIG. 4 and FIG. 8, in this embodiment, the planting pot 400 is provided with an inlet water buffer tank 410, a planting tank 420 and a water drainage channel 430; and the tail end of the flow guide member 500 is positioned above the inlet water buffer tank 410, the inlet water buffer tank 410 is in communication with the planting tank 420, the planting tank 420 is in communication with the drainage channel 430, and the tail end of the drainage channel 430 is positioned above the water tray 310. The inlet water buffer tank 410 is positioned between the planting tank 420 and the flow guide member 500 and used for buffering the wastewater entering the planting tank 420.

In some embodiments, the drainage channel 430 is further provided with a water-permeable blocking member used for blocking silt or other solid impurities in the planting tank 420 from entering the water tray 310.

As shown in FIG. 8, in this embodiment, at least two water inlet notches 421 are formed in the side wall, close to the inlet water buffer tank 410, of the planting tank 420 and are distributed in the length extending direction of the inlet water buffer tank 410. In this embodiment, two water inlet notches 421 are provided, the two water inlet notches 421 are distributed in the length direction of the inlet water buffer tank 410, and thus the wastewater can evenly enter the planting tank 420, which improves the irrigation uniformity.

The bottom surface of the drainage channel 430 is higher than the bottom surface of the planting tank 420, the bottom surfaces of the water inlet notches are higher than the bottom surface of the planting tank 420, and therefore the planting tank 420 can accommodate a certain amount of wastewater. When the planting tank 420 is full of water and the water level in the planting tank 420 is higher than the bottom surface of the drainage channel 430, the wastewater in the planting tank 420 will overflow out of the drainage channel 430 and flow into the water tray 310 of the evaporator 300 through the drainage channel 430.

In this embodiment, the bottom surface of the inlet water buffer tank 410 is higher than the bottom surface of the planting tank 420, and therefore all wastewater in the inlet water buffer tank 410 can enter the planting tank 420, which avoids water accumulation.

In this embodiment, salt is placed in the water tray 310. The salt in the water tray 310 can be dissolved in the wastewater entering the water tray 310 and plays a bacteriostatic role on the wastewater; and after the wastewater is evaporated into water vapor, the salt is separated out from the wastewater to prevent the breeding of flora in the evaporator 300 while realize recycling. The use of the salt can also reduce the frequency of replacing the water intake assemblies 320.

In this embodiment, an anti-corrosion compound is placed in the water tray 310. The anti-corrosion compound in the water tray 310 can play an anti-corrosion role on the wastewater entering the water tray 310, so that the storable time of the wastewater is prolonged, and the wastewater is prevented from being rotten and deteriorated before being completely evaporated.

In this embodiment, the evaporator 300 also includes a fan (not shown in the figure), the fan is arranged in the evaporation chamber, and an air outlet of the fan is arranged towards the water intake assemblies 320. The fan is arranged, so that the air flow rate in the evaporation chamber can be increased, the speed of the air taking away the water vapor of the wastewater is promoted, the evaporation efficiency is improved, and the treatment speed of the wastewater is accelerated.

As shown in FIG. 4 and FIG. 5, in this embodiment, a positioning frame 340 is also arranged in the evaporator 300 and positioned in the water tray 310, and the water intake assemblies 320 are detachably arranged in the positioning frame 340. The positioning frame 340 is used for limiting and fixing the positions of the water intake assemblies 320 to prevent the water intake assemblies 320 from being displaced in the transportation process, thereby improving the stability and firmness of each part of the pet water dispenser. The water intake assemblies 320 can be replaced, and the positioning frame 340 is arranged, so that the replacement of the water intake assemblies 320 can be facilitated.

In this embodiment, the evaporator 300 also includes an electric heating member which is mounted on the water tray 310. The electric heating member can heat the wastewater in the water tray 310 so as to increase the evaporation efficiency of the wastewater.

As shown in FIG. 4 to FIG. 7, in this embodiment, the control valve 220 includes a valve body 221, a valve core 222 and a driving mechanism 223, in which, the valve body 221 is provided with a first channel connector 2211 and a second channel connector 2212; the first channel connector 2211 is in communication with the water outlet end of the feed-water tank 100, and the second channel connector 2212 is in communication with the water inlet of the water tray 310; the valve core 222 is mounted on the valve body 221 and is provided with a channel opening and closing port 2221, and the channel opening and closing port 2221 is in communication with a water flow channel of the drinking bowl 210; the driving mechanism 223 is in transmission connection with the valve core 222; and the channel opening and closing port 2221 is driven by the driving mechanism 223 to move.

In this embodiment, the driving mechanism 223 is controlled by a control system.

The control valve 220 is provided with a first valve position, a second valve position and a third valve position, in which, the first valve position is a water adding position, the second valve position is a water blocking position, and the third valve position is a water draining position. The driving mechanism 223 drives the valve core 222 to rotate, thus the channel opening and closing port 2221 rotates along with the valve core 222; when the channel opening and closing port 2221 rotates to the first valve position, the channel opening and closing port 2221 corresponds to the first channel connector 2211, then the channel between the drinking bowl 210 and the water outlet end of the feed-water tank 100 is communicated, at this moment, the pet water dispenser is in the water supply state, and the feed-water tank 100 can transport water into the drinking bowl 210. After a certain amount of water is added (or after a certain time), the control system controls the driving mechanism 223 to drive the valve core 222 to rotate, so that the channel opening and closing port 2221 moves to the second valve position, at this moment, the pet water dispenser is in the waiting state for drinking water, the valve core 222 cuts off the channel between the drinking bowl 210 and the feed-water tank 100, and also cuts off the channel between the drinking bowl 210 and the water tray 310; and when the pet water dispenser is in the waiting state for water drinking for a certain time period (such as 4 h, 8 h or user-defined water changing time period), the control system controls the driving mechanism 223 to drive the valve core 222 to rotate, then the channel opening and closing port 2221 moves to the third valve position, the channel opening and closing port 2221 corresponds to the second channel connector 2212, the drinking bowl 210 is in communication with the flow guide member 500, at this moment, the pet water dispenser is in the water drainage state, and the wastewater in the drinking bowl 210 sequentially flows through the flow guide member 500 and the planting pot 400 and finally enters the water tray 310. After all water in the drinking bowl 210 is drained, the control system controls the driving mechanism 223 to control the valve core 220 to rotate, then the channel opening and closing port 2221 rotates to the first valve position again to transport water into the drinking bowl 210, and the process is circulated. In this embodiment, the driving mechanism 223 controls the valve core 220 to rotate, so that the drinking bowl 210 can switch the butted channels to realize adding and draining of water in the drinking bowl 210; and clean water is poured in and the wastewater is drained, energy consumption is low, the channels are accurately and effectively cut off, and the operation process is low in cost.

In this embodiment, the drinking device 200 further includes a water level sensor (not shown in the figure), and the water level sensor is arranged on the drinking bowl 210 and is electrically connected to the driving mechanism 223. Specifically, the water level sensor is electrically connected to the control system and used for feeding back the current water level in the drinking bowl 210 by means of the control system. In this embodiment, the water level in the drinking bowl 210 is sensed in real time by means of the water level sensor, and when the water level reaches a preset height, the water level sensor feeds back the water level to the control system, the control system transmits an instruction to the driving mechanism 223, then the driving mechanism 223 controls the valve core 222 to rotate, and therefore water adding is stopped.

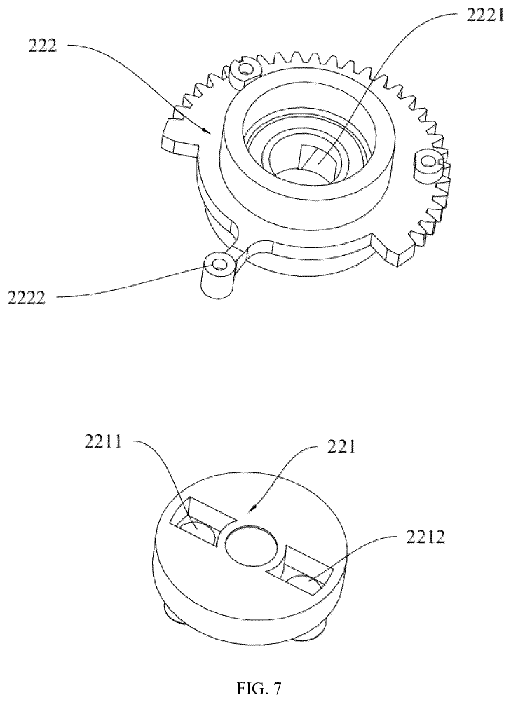

As shown in FIG. 5, FIG. 6 and FIG. 7, in this embodiment, the valve core 222 is provided with a position indicating portion 2222; and the control valve 220 further includes a position sensor 224 which is arranged corresponding to the position indicating portion 2222 and is electrically connected to the driving mechanism 223. Specifically, the position sensor 224 is electrically connected to the control system, and the control system is electrically connected to the driving mechanism 223. In this embodiment, the position sensor 224 is arranged to sense the position indicating portion 2222 on the valve core 222, so that whether the position of the channel opening and closing port 2221 of the valve core 222 is in the first valve position or the second valve position or the third valve position can be determined, then the acquired position information is fed back to the control system, the control system will transmit the instruction to the driving mechanism 223 to make the valve core 222 continuously rotate to a preset position or stop rotating. The position sensor 224 is arranged so that the rotation error of the valve core 222 can be effectively avoided, and the linkage accuracy and reliability of all parts are improved.

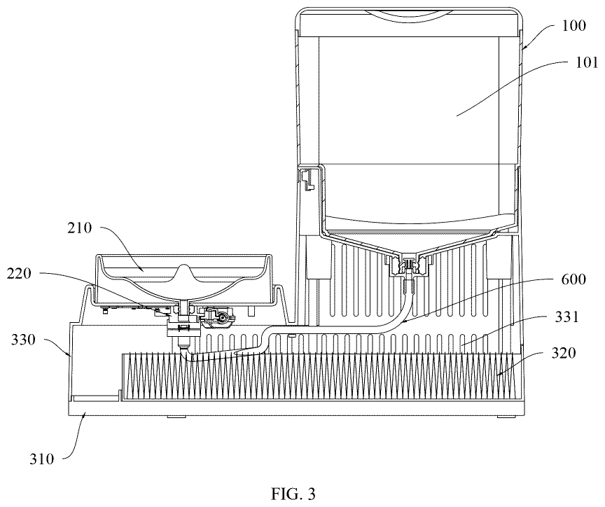

As shown in FIG. 3 to FIG. 6, in this embodiment, the pet water dispenser further includes a connecting water pipe 600, one end of the connecting water pipe 600 is in communication with the feed-water tank 100, and the other end of the connecting water pipe 600 is in communication with the first channel connector 2211; and the connecting water pipe 600 is positioned above the water tray 310.

In this embodiment, the drinking bowl 210 is lower than the bottom of the feed-water tank 100, and the water tray 310 is lower than the bottom of the drinking bowl 210. Specifically, the drinking bowl 210 is lower than the bottom of the feed-water tank 100, so that when the control valve 220 communicates the drinking bowl 210 with the feed-water tank 100, water in the feed-water tank 100 can enter the drinking bowl 210 through the connecting water pipe 600 due to the weight of the water. The water tray 310 is lower than the bottom of the drinking bowl 210, so that when the control valve 220 communicates the water tray 310 with the drinking bowl 210, the water in the drinking bowl 210 can enter the water tray 310 due to the weight of the water. The pet water dispenser is simple in overall structure and high in practicability.

The above provides a detailed description of the specific implementation methods of the present application. The implementation methods disclosed above are merely preferred embodiments of the present application, and ordinary technicians in this field can make many modifications and improvements without deviating from the concept of the present application. These modifications and improvements are all within the scope of protection defined by the claims of the present application.

What is claimed is:

1. A pet water dispenser, comprising:
a feed-water tank in which a water container is arranged;
a drinking device comprising a drinking bowl and a control valve, the control valve being connected to the drinking bowl and the feed-water tank, and the control valve controlling communication and separation between the drinking bowl and the feed-water tank; and
an evaporator comprising a water tray and a water intake assembly, the water tray being in butt joint with the control valve, the control valve controlling the communication and separation between the drinking bowl and the water tray, and the water intake assembly being arranged in the water tray, with the surface area greater than the bottom area of the water tray.

2. The pet water dispenser according to claim 1, wherein the evaporator is positioned below the feed-water tank and further comprises a shell; the feed-water tank and the drinking bowl are both mounted on the shell; the shell and the water tray are assembled to form an evaporation chamber, and the water intake assembly is positioned in the evaporation chamber; and air holes are formed in the side wall of the shell, and the evaporation chamber is in communication with outside through the air holes.

3. The pet water dispenser according to claim 2, wherein the water intake assembly is of a plate-shaped structure folded in a wavy mode.

4. The pet water dispenser according to claim 2, wherein the top surface of the water intake assembly is higher than the top surface of the water tray.

5. The pet water dispenser according to claim 2, wherein a part of the water tray is positioned below a joint of the drinking bowl and the control valve.

6. The pet water dispenser according to claim 2, further comprising a planting pot, wherein the planting pot is mounted on one side of the evaporator, a water inlet of the planting pot is in communication with the drinking bowl, and a water outlet of the planting pot is in butt joint with a water inlet of the water tray.

7. The pet water dispenser according to claim 6, further comprising a flow guide member which is positioned between the drinking bowl and the planting pot, wherein the head end of the flow guide member is in butt joint with the control valve, and the tail end of the flow guide member is positioned at the water inlet of the planting pot.

8. The pet water dispenser according to claim 7, wherein the tail end of the flow guide member is positioned above the water tray, and the planting pot is detachably connected to the water tray.

9. The pet water dispenser according to claim 7, wherein the planting pot is provided with an inlet water buffer tank, a planting tank and a water drainage channel; the tail end of the flow guide member is positioned above the inlet water buffer tank, the inlet water buffer tank is in communication with the planting tank, the planting tank is in communication with the drainage channel, and the tail end of the drainage channel is positioned above the water tray.

10. The pet water dispenser according to claim 9, wherein at least two water inlet notches are formed in the side wall, close to the inlet water buffer tank, of the planting tank and are distributed in the length extending direction of the inlet water buffer tank.

11. The pet water dispenser according to claim 9, wherein the bottom surface of the inlet water buffer tank is higher than the bottom surface of the planting tank.

12. The pet water dispenser according to claim 1, wherein salt is placed in the water tray.

13. The pet water dispenser according to claim 12, wherein an anti-corrosion compound is placed in the water tray.

14. The pet water dispenser according to claim 13, wherein the evaporator also comprises a fan which is mounted in the evaporation chamber, and an air outlet of the fan is arranged towards the water intake assembly.

15. The pet water dispenser according to claim 13, wherein the evaporator also comprises an electric heating member which is mounted on the water tray.

16. The pet water dispenser according to claim 1, wherein a positioning frame is also arranged in the evaporator and is positioned in the water tray, and the water intake assembly is detachably arranged in the positioning frame.

17. The pet water dispenser according to claim 1, wherein the control valve comprises a valve body, a valve core and a driving mechanism; the valve body is provided with a first channel connector and a second channel connector, the first channel connector is in communication with the water outlet end of the feed-water tan, and the second channel connector is in communication with the water inlet of the water tray; the valve core is mounted on the valve body and is provided with a channel opening and closing port, and the channel opening and closing port is in communication with a water flow channel of the drinking bowl; the driving mechanism is in transmission connection with the valve core; and the channel opening and closing port is driven by the driving mechanism to move.

18. The pet water dispenser according to claim 17, wherein a position indicating portion is arranged on the valve core; and the control valve further comprises a position sensor which is arranged corresponding to the position indicating portion, and the position sensor is electrically connected to the driving mechanism.

19. The pet water dispenser according to claim 17, further comprising a connecting water pipe, wherein one end of the connecting water pipe is in communication with the feed-water tank, and the other end of the connecting water pipe is in communication with the first channel connector; and the connecting water pipe is positioned above the water tray.

20. The pet water dispenser according to claim 1, wherein the drinking bowl is lower than the bottom of the feed-water tank, and the water tray is lower than the bottom of the drinking bowl.
